(19) United States
(12) Patent Application Publication
(10) Pub. No.: US 2022/0179756 A1
(43) Pub. Date: Jun. 9, 2022

(54) COMPUTER SYSTEM AND METHOD CAPABLE OF SELF-MONITORING AND RESTORING AN OPERATION OF OPERATING SYSTEM

(71) Applicant: INNODISK CORPORATION, NEW TAIPEI CITY (TW)

(72) Inventors: CHAN WEI FAN, NEW TAIPEI CITY (TW); CHIH-CHING WU, NEW TAIPEI CITY (TW)

(21) Appl. No.: 17/475,812

(22) Filed: Sep. 15, 2021

(30) Foreign Application Priority Data
Dec. 3, 2020 (TW) 109142636

(51) Int. Cl. G06F 11/14

(52) U.S. Cl. CPC G06F 11/1469; G06F 11/1417; G06F 11/1464; G06F 11/1451

(57) ABSTRACT

The invention a computer system is disclosed. The computer system comprises a motherboard and a data storage device. The data storage device comprises a controller and a data storage unit. The controller comprises a firmware. The data storage unit comprises a first system storage sector and a second system storage sector. The first system storage sector stores an original operating system, and a monitoring program is installed in the original operating system. The monitoring program periodically sends an indication signal to the controller. The second system storage sector stores a backup operating system. If the controller doesn't receive the indication signal from the monitoring program, the firmware will execute an operating system recovery procedure to recover the original operating system of the first system storage sector by the backup operating system of the second system storage sector.

This non-provisional application claims priority claim under 35 U.S.C. § 119(a) on Taiwan Patent Application No. 109142636 filed Dec. 3, 2020, the entire contents of which are incorporated herein by reference.

### FIELD OF THE INVENTION

The present invention relates to a computer system capable of self-monitoring and restoring an operation of operating system.

### BACKGROUND

In the past, the computer manufacturer would store a system image file in a computer before the computer is shipped. When the operating system has damaged, user can execute an operating system recovery procedure via the system image file, and the operating system recovery procedure is executed in a miniaturized system. A data storage sector of a data storage device inside the computer is divided into a system sector and a backup sector. The system sector stores an operating system, and the backup sector stores the system image file and the miniaturized system (such as Windows PE).

A computer host may be configured with a recovery button connected to the motherboard. When the operating system of the computer host has damaged, manager can press the recovery button to trigger a recovery operating system function. When the recovery operating system function is triggered, BIOS can execute a boot operation via the miniaturized system of the backup sector. After the miniaturized system has executed the boot operation, the system image file can be decompressed by the operation of the miniaturized system, and the operating system can be recovered via the system image file decompressed.

Otherwise, a baseboard management controller (BMC) may be configured on a motherboard of the computer host. A remote administrator is connected to the computer host by an electronic device (such as smart phone), monitors the operation of the operating system of the computer host via the use of BMC. When the operating system of the computer host has damaged, the remote administrator can control the miniaturized system to execute the operating system recovery procedure via BMC so as to recover the operating system.

Thus, the administrator can recover the damaged operating system by pressing the recovery button or controlling the miniaturized system through BMC. However, in the implementation of the above way, the administrator needs to personally operate the operating system recovery procedure regardless of on-site or remote location; otherwise, the damaged operating system cannot be recovered.

### SUMMARY

It is one objective of the present invention to provide a computer system, which comprises a data storage device. The data storage device comprises a controller and a data storage unit. The controller comprises a firmware. An operating system recovery procedure is defined in the firmware. The data storage unit comprises a first system storage sector and a second system storage sector. The first system storage sector stores an original operating system, and the second system storage sector stores a first backup operating system. A monitoring program is installed in the original operating system, and is able to periodically send an indication signal to the controller. If the controller doesn't receive the indication signal sent from the monitoring program in a predetermined time counted by the timer, the firmware of the controller executes the operating system recovery procedure to recover the original operating system via the first backup operating system. After the original operating system has recovered, the firmware of the controller again executes the boot operation by the recovered original operating system, and then executes the operations of the recovered original operating system.

It is another objective of the present invention to provide a computer system, in which the firmware of the controller further defines a boot pointer offset procedure. The firmware of the controller presets a boot pointer to point to a first initial sector address of the first system storage sector, and sets the first initial sector address as a master boot sector address. When the original operating system is operating normally, the firmware of the controller reads a master boot record from the first initial sector address, and executes a boot operation of the original operating system by the master boot record in the first initial sector address. If the controller doesn't receive the indication signal sent from the monitoring program in a predetermined time counted by the timer, the firmware of the controller executes the boot pointer offset procedure to offset the boot pointer from pointing to a first initial sector address of the first system storage sector to pointing to a second initial sector address of the second system storage sector, reads a master boot record from the second initial sector address, and executes the boot operation of the first backup operating system by the master boot record in the second initial sector address. Accordingly, when the original operating system has damaged, the boot operation of the computer system can be restored quickly via the first backup operating system, and therefore the computer system may continue to execute the operations by the use of the first backup operating system.

It is another objective of the present invention to provide a computer system, wherein the data storage unit further comprises a third system storage sector. The third system storage sector stores a second backup operating system. During the execution of the first backup operating system of the second system storage sector, the firmware of the controller executes the operating system recovery procedure to recover the original operating system of the first system storage sector via the second backup operating system of the third system storage sector, and converts the recovered original operating system into a new backup operating system.

It is another objective of the present invention to provide a computer system, in which a resetting operation of the computer system can be executed by the firmware of the controller before the execution of the operating system recovery procedure or the boot pointer offset procedure. If the controller can continually receive the indication signal sent from the monitoring program after the resetting operation of the computer system has finished, the firmware will prohibit the execution of the operating system recovery procedure or the boot pointer offset procedure. On the contrary, if the controller doesn't still receive the indication signal after the resetting operation of the computer system has finished, it represents that the original operating system 232 has damaged, the firmware will execute the operating system recovery procedure or the boot pointer offset procedure.

To achieve the above objective, the present invention provides a computer system capable of self-monitoring and restoring an operation of operating system, comprising: a motherboard; and a data storage device, comprising: a controller comprising a firmware that defines an operating system recovery procedure; a data transmission interface connected to the controller and the motherboard; and a data storage unit, connected to the controller, and comprising: a first system storage sector for storing an original operating system, wherein a monitoring program is installed in the original operating system, and used to periodically send an indication signal to the controller; and a second system storage sector for storing a backup operating system; wherein if the controller doesn't receive the indication signal sent from the monitoring program, the firmware will execute an operating system recovery procedure to recover the original operating system of the first system storage sector via the backup operating system of the second system storage sector.

In one embodiment of the present invention, wherein the data storage device further comprises a timer that is configured in the data storage device in a form of circuit, or configured in the firmware of the controller in a form of software; the firmware will execute the operating system recovery procedure if the controller doesn't receive the indication signal sent from the monitoring program in a predetermined time counted by the timer.

In one embodiment of the present invention, wherein the controller comprises an input and output pin, the motherboard comprises a reset pin, the input and output pin is connected to the reset pin; if the controller doesn't receive the indication signal sent from the monitoring program, the controller executes a resetting operation of the computer system by controlling the reset pin via the input and output pin; if the controller doesn't still receive the indication signal sent from the monitoring program after the resetting operation of the computer system has finished, the firmware will execute the operating system recovery procedure.

In one embodiment of the present invention, wherein a state of the first system storage sector is preset as a display state by the firmware, and a state of the second system storage sector is preset as a hidden state by the firmware; the second system storage sector is an over provisioning sector of the data storage unit.

The present invention further provides a computer system capable of self-monitoring and restoring an operation of operating system, comprising: a motherboard; and a data storage device, comprising: a controller comprising a firmware, wherein the firmware defines a boot pointer offset procedure; a data transmission interface connected to the controller and the motherboard; and a data storage unit, connected to the controller, and comprising: a first system storage sector, used for storing an original operating system, and comprising a first initial sector address; wherein a monitoring program is installed in the original operating system, and used to periodically send an indication signal to the controller; and a second system storage sector, used for storing a first backup operating system, and comprising a second initial sector address; wherein a boot pointer is preset by the firmware to point to the first initial sector address of the first system storage sector; if the controller doesn't receive the indication signal sent from the monitoring program, the firmware executes the boot pointer offset procedure to offset the boot pointer from pointing to the first initial sector address to pointing to the second initial sector address, and then executes a boot operation by the first backup operating system.

In one embodiment of the present invention, wherein the data storage device further comprises a timer that is configured in the data storage device in a form of circuit, or configured in the firmware of the controller in a form of software; the firmware will execute the boot pointer offset procedure if the controller doesn't receive the indication signal sent from the monitoring program in a predetermined time counted by the timer.

In one embodiment of the present invention, wherein the controller comprises an input and output pin, the motherboard comprises a reset pin, the input and output pin is connected to the reset pin; if the controller doesn't receive the indication signal sent from the monitoring program, the controller executes a resetting operation of the computer system by controlling the reset pin via the input and output pin; when the controller doesn't still receive the indication signal sent from the monitoring program after the resetting operation of the computer system has finished, the firmware will execute the boot pointer offset procedure.

In one embodiment of the present invention, wherein the firmware defines an operating system recovery procedure, the data storage unit further comprises a third system storage sector used for storing a second backup operating system; when the first backup operating system finishes the boot operation and operates normally, the firmware executes the operating system recovery procedure to recover the original operating system of the first system storage sector by the second backup operating system of the third system storage sector.

In one embodiment of the present invention, wherein a state of the first system storage sector is preset as a display state by the firmware, the second system storage sector is a first over provisioning sector of the data storage unit, the third system storage sector is a second over provisioning sector of the data storage unit, states of the second system storage sector and the third system storage sector are preset as hidden states by the firmware; when the boot pointer is offset from pointing to the first initial sector address to pointing to the second initial sector address, the firmware converts the state of the first system storage sector from the display state to the hidden state, and converts the state of the second system storage sector from the hidden state to the display state.

The present invention further provides a method for capable of self-monitoring and restoring an operation of operating system, which is applied to a computer system, wherein the computer system comprises a motherboard and a data storage device; the data storage device comprises a controller, a data transmission interface, and a data storage unit; the controller comprises a firmware that defines an operating system recovery procedure; the data storage unit comprises a first system storage sector and a second system storage sector; the first system storage sector stores an original operating system installed with a monitoring program, and the second system storage sector stores a backup operating system, the method comprising: sending an indication signal to the controller via the monitoring program periodically; and executing the operating system recovery procedure by the firmware if the controller doesn't receive the indication signal sent by the monitoring program to recover the original operating system of the first system storage sector by the backup operating system of the second system storage sector.

In one embodiment of the present invention, the method further comprising: executing the operating system recovery procedure by the firmware if the controller doesn't receive the indication signal sent from the monitoring program in a predetermined time counted by a timer.

In one embodiment of the present invention, the method further comprising: executing a resetting operation of the computer system by the controller if the controller doesn't receive the indication signal sent from the monitoring program; and executing the operating system recovery procedure by the firmware if the controller doesn't still receive the indication signal sent from the monitoring program after the resetting operation of the computer system has finished.

The present invention further provides a method for capable of self-monitoring and restoring an operation of operating system, which is applied to a computer system, wherein the computer system comprises a motherboard and a data storage device; the data storage device comprises a controller, a data transmission interface, and a data storage unit; the controller comprises a firmware that defines a boot pointer offset procedure; the data storage unit comprises a first system storage sector and a second system storage sector; the first system storage sector stores an original operating system installed with a monitoring program, and comprises a first initial sector address; the second system storage sector stores a first backup operating system, and comprises a second initial sector address, the method comprising: sending an indication signal to the controller via the monitoring program periodically; and executing the boot pointer offset procedure by the firmware to offset the boot pointer from pointing to the first initial sector address to pointing to the second initial sector address such that a boot operation is executed by the first backup operating system.

In one embodiment of the present invention, the method further comprising: executing the boot pointer offset procedure by the firmware if the controller doesn't receive the indication signal sent from the monitoring program in a predetermined time counted by a timer.

In one embodiment of the present invention, the method further comprising: executing a resetting operation of the computer system by the controller if the controller doesn't receive the indication signal sent from the monitoring program; and executing the boot pointer offset procedure by the firmware if the controller doesn't still receive the indication signal sent from the monitoring program after the resetting operation of the computer system has finished.

In one embodiment of the present invention, wherein the firmware defines an operating system recovery procedure, the data storage unit further comprises a third system storage sector used for storing a second backup operating system; when the first backup operating system finishes the boot operation and operates normally, the method executed by the firmware of the controller further comprising: executing the operating system recovery procedure to recover the original operating system of the first system storage sector by the second backup operating system of the third system storage sector.

### BRIEF DESCRIPTION OF THE DRAWINGS

FIG. 1 is a structural view of a computer system of the present invention.

FIG. 2 is a schematic diagram of a data sector of a data storage unit of the data storage device according to one embodiment of the present invention.

FIG. 3 is a schematic diagram of the data sector of the data storage unit of the data storage device according to another embodiment of the present invention.

FIG. 4 is a schematic diagram of the data sector of the data storage unit of the data storage device according to another embodiment of the present invention.

FIG. 5 is a flow chart of a method capable of self-monitoring and restoring an operation of operating system according to one embodiment of the present invention.

FIG. 6 is a flow chart of a method capable of self-monitoring and restoring an operation of operating system according to another embodiment of the present invention.

### DETAILED DESCRIPTION OF THE PREFERRED EMBODIMENTS

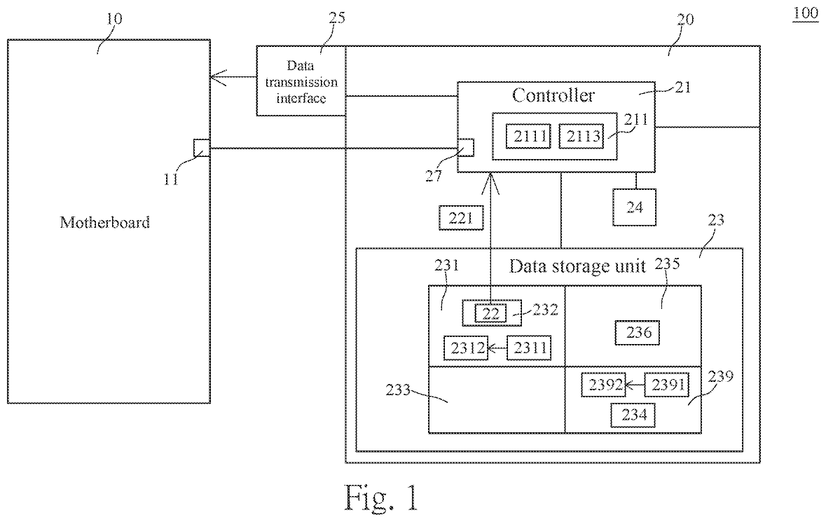

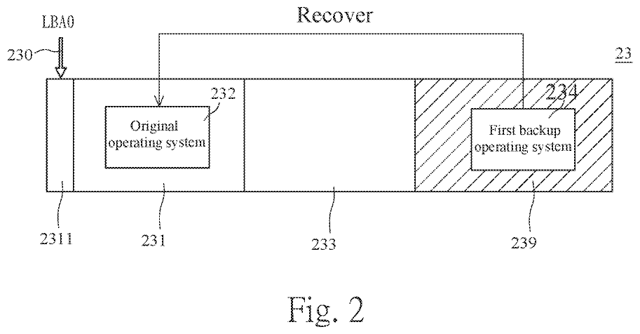

Referring to FIG. 1 and FIG. 2, there are shown a structural view of a computer system of the present invention, and a schematic diagram of a data sector of a data storage unit of the data storage device according to one embodiment of the present invention. As shown in FIG. 1, a computer system 100 comprises a motherboard 10 and a data storage device 20. The data storage device 20 is a SSD (Solid State Disk), and comprises a controller 21, a data storage unit 23, and a data transmission interface 25. The controller 21 is connected to the data storage unit 23, and the data transmission interface 25, respectively. The data storage device 20 is connected to the motherboard 10 via the data transmission interface 25. The data transmission interface 25 may be a data transmission interface conforming to SATA, PCIe, or USB standard specification.

The controller 21 comprises a firmware 211. In the present invention, the firmware 211 defines an operating system recovery procedure 2111. The data storage unit 23 comprises a plurality of flash memories, which are formed with a plurality of data sectors. As shown in FIG. 2, the data sectors of the data storage unit 23 are divided by the firmware 211 of the controller 21 into a first system storage sector 231, a data storage sector 233, and a second system storage sector 239. The first system storage sector 231 stores an original operating system 232. The data storage sector 233 stores general data. The second system storage sector 239 stores a first backup operating system 234.

A state of the first system storage sector 231 and a state of the data storage sector 233 are preset as a display state by the firmware 211, respectively. A state of the second system storage sector 239 is preset as a hidden state by the firmware 211. In the present invention, the sector in the hidden state is a physical storage space that is unable to be viewed by the operating system or BIOS via the logical block address. For example, the second system storage sector 239 is an over provisioning (OP) sector reserved by SSD manufacturer.

Furthermore, the first system storage sector 231 comprises a first initial sector address 2311. The data sector of the first initial sector address 2311 has a master boot record (MBR) 2312. In the present invention, a boot pointer 230 is preset by the firmware 211 of the controller 21 to point to the first initial sector address 2311 of the first system storage sector 231 such that the first initial sector address 2311 is as a master boot sector address, for example, the zeroth logical block addressing (logical block addressing 0, LBA 0). When the computer system 100 is power on, the firmware 211 of the controller 21 enters the first system storage sector 231 of the data storage unit 13 according to the indication of the boot pointer 230, reads the master boot record 2312 from the first initial sector address 2311 of the first system storage sector 231, and executes a boot operation of the original operating system 232 by the master boot record 2312. After the original operating system 232 has booted normally, the computer system 100 will perform the operations in the operating environment of the original operating system 232.

Further, a monitoring program 22 is installed in the original operating system 232. The original operating system 232 may be a watchdog program. The computer system 100 monitors the operation of the original operating system 232. In the present invention, the monitoring program 22 periodically sends an indication signal 221 to the controller 21. The indication signal 221 is a signal for indicating that the original operating system 232 operates in normal. If the controller 21 receives the indication signal 221 sent from the monitoring program 22, the firmware 211 of the controller 21 can know that the original operating system 232 is in a normal operating state.

The data storage device 20 further comprises a timer 24. The timer 24 is configured in the data storage device 20 in a form of circuit, or configured in the firmware 211 of the controller 21 in a form of software. If the controller 21 doesn't receive the indication signal 221 sent from the monitoring program 22 in a predetermined time counted by the timer 24, the firmware 211 of the controller 21 determines that the original operating system 232 is in an abnormal state. The monitoring program 22 will be closed when the original operating system 232 is in the abnormal state, and therefore it unable to send the indication signal 221 to the controller 21. Afterwards, the firmware 211 of the controller 21 executes the operating system recovery procedure 2111 to recover the original operating system 232 operated in the abnormal state via the first backup operating system 234 of the second system storage sector 239. After the original operating system 232 has recovered, the firmware 211 of the controller 21 again executes the boot operation by the recovered original operating system 232, and then executes the operations of the recovered original operating system 132. In the present invention, the predetermined time counted by the timer 24 is greater than an interval time that the monitoring program 22 sends the indication signal 221.

The controller 21 further comprises an input and output pin 27. The motherboard 10 comprises a reset pin 11. The controller 21 is connected to the reset pin 11 via the input and output pin 27. If the controller 21 doesn't receive the indication signal 221 sent from the monitoring program 22, it may just be the crash of the original operating system 232. Therefore, the controller 21 executes a resetting operation of the computer system 100 by controlling the reset pin 11 via the input and output pin 27 before the operating system recovery procedure 2111 is executed. If the controller 21 can continually receive the indication signal 221 sent from the monitoring program 22 after the resetting operation of the computer system 100 has finished, it represents that the previous abnormality of the original operating system 232 is only general crash condition, the firmware 211 will prohibit the execution of the operating system recovery procedure 2111. On the contrary, if the controller 21 doesn't still receive the indication signal 221 after the resetting operation of the computer system 100 has finished, it represents that the original operating system 232 has damaged, the firmware 211 will continue to execute the operating system recovery procedure 2111 to recover the original operating system 232 of the first system storage sector 231 via the backup operating system 234 of the second system storage sector 239.

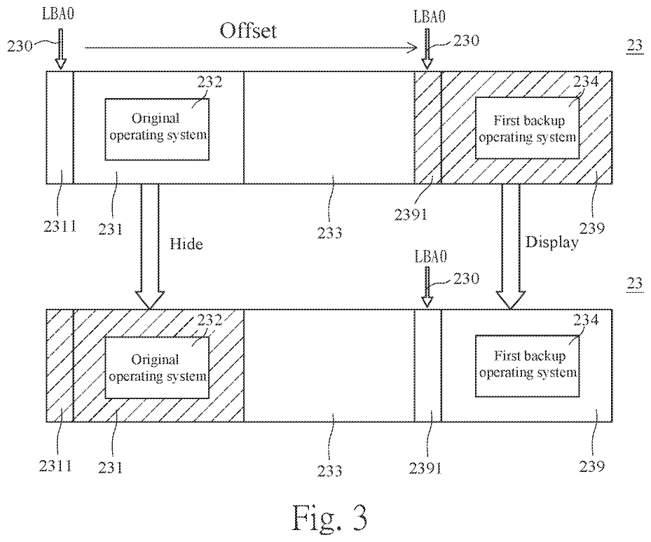

Referring to FIG. 3, there is a schematic diagram of the data sector of the data storage unit of the data storage device according to another embodiment of the present invention, with simultaneously reference to FIG. 1. As shown in FIG. 1 and FIG. 3, the second system storage sector 239 further comprises a second initial sector address 2391, and the data sector of the second initial sector address 2391 has other master boot record (MBR) 2392. The firmware 211 of the controller 21 further defines a boot pointer offset program 2113. In one embodiment of the present invention, the master boot records 2312, 2392 are partition tables of BIOS, and the controller 21 executes the boot operation by loading the master boot records 2312, 2392. In another embodiment of the present invention, GUID partition table (GPT) of UEFI can be used to replace the master boot records 2312, 2392, and then the controller 21 executes the boot operation by loading GPT.

If the controller 21 doesn't receive the indication signal 221 sent from the monitoring program 22 in the predetermined time counted by the timer 24, the firmware 21 will execute the boot pointer offset procedure 2113 to offset the boot pointer 230 from pointing to the first initial sector address 2311 to pointing to the second initial sector address 2391, and then convert the state of the first system storage sector 231 from the display state to the hidden state and convert the state of the second system storage sector 239 from the hidden state to the display state; that is, the first system storage sector 231 is converted as a reserved space that cannot be operated by the user using the operating system or BIOS, and the second system storage sector 239 is converted as a storage space that can be accessed normally. Then, the firmware 211 of the controller 21 reads the master boot record 2392 from the second initial sector address 2391 of the second system storage sector 239, and executes the boot operation of the first backup operating system 234 according to the master boot record 2392. After the first backup operating system 234 is normally booted, the computer system 100 will perform operations according to the first backup operating system 234.

Similarly, before the boot pointer offset procedure 2113 executes, the controller 21 will also execute the resetting operation of the computer system 100 by controlling the reset pin 11 via the input and output pin 27. If the controller 21 can continually receive the indication signal 221 sent from the monitoring program 22 after the resetting operation of the computer system 100 has finished, it represents that the previous abnormality of the original operating system 232 is only general crash condition, the firmware 211 will prohibit the execution of the boot pointer offset procedure 2113. On the contrary, if the controller 21 doesn't still receive the indication signal 221 after the resetting operation of the computer system 100 has finished, it represents that the original operating system 232 has damaged, the firmware 211 will continue to execute the boot pointer offset procedure 2113 so as to execute the boot operation by the first backup operating system 234 of the second system storage sector 239.

Accordingly, when the original operating system 232 damages, the firmware 211 of the controller 21 converts the execution of the boot operation from the original operating system 232 to the first backup operating system 234 by offsetting the boot pointer 230, such that the boot operation of the computer system 100 can be restored quickly, and further the computer system 100 may continue to execute operations by the use of the first backup operating system 234.

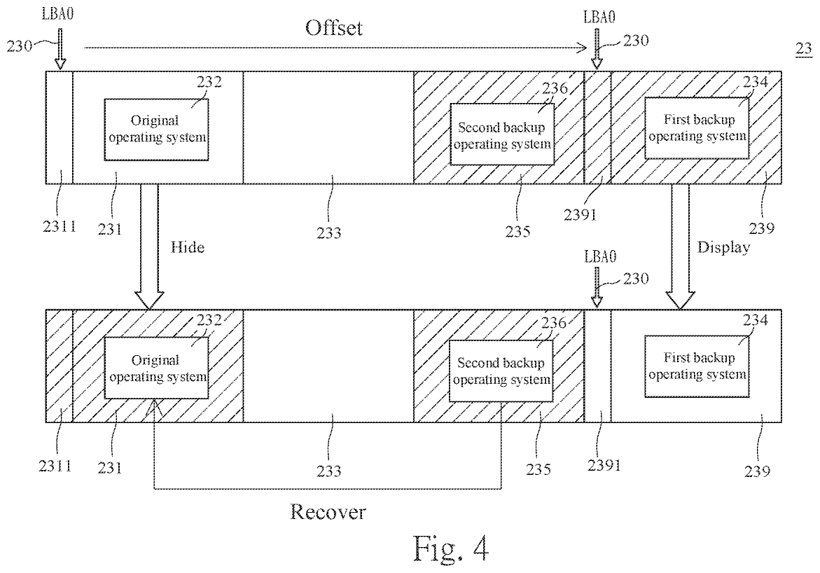

Referring to FIG. 4, there is a schematic diagram of the data sector of the data storage unit of the data storage device according to another embodiment of the present invention, with simultaneously reference to FIG. 1. As shown in FIG. 1 and FIG. 4, a third system storage sector 235 is further divided from the data sectors of the data storage unit 23 by the firmware 211 of the controller 21. Similar to the second system storage sector 239, a state of the third system storage sector 235 is also preset as the hidden state by the firmware 211. The third system storage sector 235 is another over provisioning sector of the data storage unit 23, and unable to be accessed by the logical block address.

If the controller 21 doesn't receive the indication signal 221 sent from the monitoring program 22 in the predetermined time counted by the timer 24, it will execute the resetting operation of the computer system 100. The controller 21 can continually receive the indication signal 221 sent from the monitoring program 22 after the resetting operation of the computer system 100 has finished, the firmware 211 will prohibit the execution of the boot pointer offset procedure 2113. On the contrary, if the controller 21 doesn't still receive the indication signal 221 after the resetting operation of the computer system 100 has finished, it represents that the original operating system 232 has damaged, the firmware 211 will continue to execute the boot pointer offset procedure 2113 so as to execute the boot operation by the first backup operating system 234 of the second system storage sector 239.

During the execution of the boot pointer offset procedure 2113, the firmware 211 offsets the boot pointer 230 from pointing to the first initial sector address 2311 of the first system storage sector 231 to pointing to the second initial sector address 2391 of the second system storage sector 239, and sets the second initial sector address 2391 as the master boot sector address (LBA0). After the boot pointer 230 is pointing to the second initial sector address 2391, the firmware 211 of the controller 21 converts the state of the first system storage sector 231 from the display state to the hidden state, and converts the state of the second system storage sector 239 from the hidden state to the display state.

Then, the firmware 211 of the controller 21 reads the master boot record 2392 from the second initial sector address 2391 of the second system storage sector 239, and executes the boot operation of the first backup operating system 234 by the master boot record 2392. When the first backup operating system 234 has booted and is operating, the firmware 211 of the controller 21 further executes the operating system recovery procedure 2111 to read the second backup operating system 236 of the third system storage sector 235, and recover the original operating system 232 of the first system storage sector 231 by the use of the second backup operating system 236. When the original operating system 232 is recovered, the firmware 211 displays the first system storage sector 231 and hides the second system storage sector 239, executes the boot operation by the recovered original operating system 232, and then executes the operations of the computer system 100 by the recovered original operating system 232.

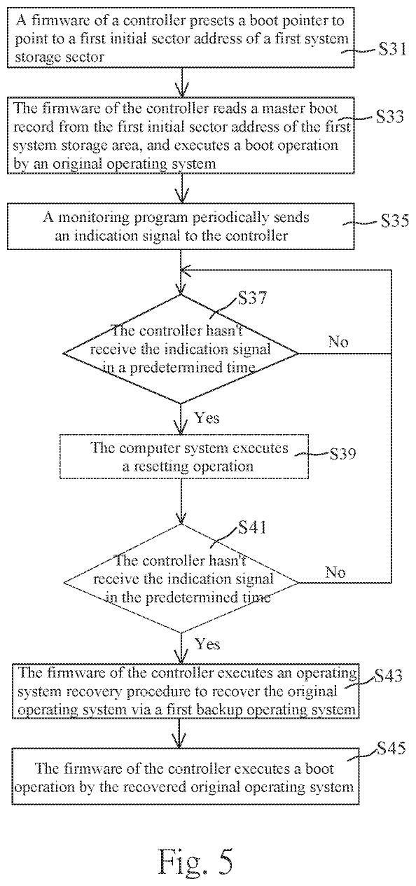

Referring to FIG. 5, there is a flow chart of a method capable of self-monitoring and restoring an operation of operating system according to one embodiment of the present invention, with simultaneous reference to FIG. 1 and FIG. 2. As shown in FIGS. 1 and 2, the data storage unit 23 of the data storage device 20 is divided into a first system storage sector 231, a data storage sector 233, and a second system storage sector 239. A state of the first system storage sector 231 is preset as a display state by the firmware 211 of the controller 21, and stores an original operating system 232. The second system storage sector 239 is preset as a hidden state by the firmware 211 of the controller 21, and stores a first backup operating system 234. Besides, the first system storage sector 231 comprises a first initial sector address 2311 having a master boot record 2312.

As shown in FIG. 5, in step S31, firstly, the firmware 211 of the controller 21 presets a boot pointer 230 to point to the first initial sector address 2311 of the first system storage sector 231, and sets the first initial sector address 2311 as a master boot sector address. In step S33, when the computer system 100 is power on, the firmware 211 of the controller 21 reads the master boot record 2312 from the first initial sector address 2311 of the first system storage sector 231, and executes the boot operation according to the original operating system 232 of the first system storage sector 231.

In step S35, when the original operating system 232 is successfully booted and operating, the monitoring program 22 will be activated, and can send an indication signal 221 to the controller 21. In step S37, the firmware 211 determines whether the controller 21 has or has not receive the indication signal 221 sent from the monitoring program 22 in a predetermined time; if the controller 21 has received the indication signal 221, the firmware 211 continues to perform step S37; otherwise, the firmware 211 performs step S43, the firmware 211 will execute an operating system recovery procedure 2111 to read the first backup operating system 234 from the second system storage sector 239, and recover the original operating system 232 of the first system storage sector 231 by the first backup operating system 234. In step S45, finally, the firmware 211 of the controller 21 again executes the recovered original operating system 232, and then executes the operations of the computer system 100 by the recovered original operating system 232.

Before the operating system recovery procedure 2111 in step S43 is performed, it further includes steps S39 and S41. In step S39, the controller 21 executes the resetting operation of the computer system 100. In step S41, the firmware 211 again determines whether the controller 21 has or has not receive the indication signal 221 sent from the monitoring program 22 in a predetermined time; if the controller 21 has received, the original operating system 232 has restored the normal operation, returning to step S37; otherwise, the original operating system 232 has damaged, continuing to perform steps S43 and S45.

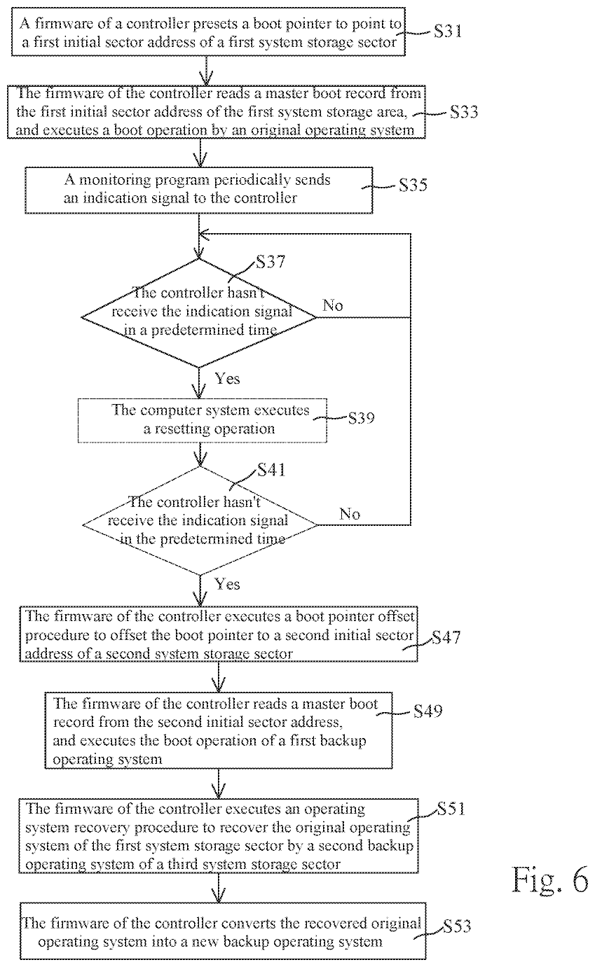

Referring to FIG. 6, there is a flow chart of a method capable of self-monitoring and restoring an operation of operating system according to another embodiment of the present invention, with simultaneous reference to FIGS. 1 and 3. Firstly, steps S31 to S37 in the embodiment of FIG. 6 are same as the steps S31 to S37 in the embodiment of FIG. 5. Furthermore, the second system storage sector 239 comprises a second initial sector address 2392 having a master boot record 2392.

In step S37, if the firmware 211 doesn't receive the indication signal 221 sent from the monitoring program 22 in a predetermined time counted by the timer 24, step S47 will be performed. In step S47, the firmware 211 of the controller 21 executes a boot pointer offset procedure 2113 to offset the boot pointer 230 from pointing to the first initial sector address 2311 of the first system storage sector 231 to pointing to the second initial sector address 2391 of the second system storage sector 239, and sets the second initial sector address 2391 as the master boot sector address. Then, continuing to perform step S49, the firmware 211 of the controller 21 converts the state of the first system storage sector 231 from the display state to the hidden state, converts the state of the second system storage sector 239 from the hidden state to the display state, reads the master boot record 2392 from the second initial sector address 2391 of the second system storage sector 239, and executes the boot operation by the first backup operating system 234 of the second system storage sector 239. Afterwards, the computer system 100 can be operated by the use of the first backup operating system 234.

Before the boot pointer offset procedure 2113 in step S47 is performed, it further includes steps S39 and S41. In step S39, the controller 21 executes the resetting operation of the computer system 100. In step S41, the firmware 211 again determines whether the controller 21 has or has not receive the indication signal 221 sent from the monitoring program 22 in a predetermined time, if the controller 21 has received the indication signal 221, the crashed original operating system 232 has restored the normal operation, returning to step S37; otherwise, the original operating system 232 has damaged, continuing to perform steps S47 and S49.

Furthermore, referring to FIG. 4, a third system storage sector 235 is further divided from the data sectors of the data storage unit 23 by the firmware 211 of the controller 21. A state of the third system storage sector 235 is also preset as the hidden state by the firmware 211. The third system storage sector 235 is other over provisioning sector of the data storage unit 23, and stores a second backup operating system 236.

Continuing to perform steps S51, during the first backup operating system 234 is executed, the firmware 211 will execute the operating system recovery procedure 2111 to read the second backup operating system 236 from the hidden third system storage sector 235, and recover the original operating system 232 of the first system storage sector 231 by the second backup operating system 236. In step S53, finally, the first backup operating system 234 continues to operate, the firmware 211 of the controller 21 converts the recovered original operating system 232 into a new backup operating system. In another embodiment of the present invention, otherwise, when the original operating system 232 has recovered, the firmware 211 of the controller 21 can execute the reboot operation of the computer system 100, convert the state of the first system storage sector 231 from the hidden state to the display state, convert the state of the second system storage sector 239 from the display state to the hidden state, and execute the boot process via the recovered original operating system 232, such that the computer system 100 can be operated by the recovered original operating system 232.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. A computer system capable of self-monitoring and restoring an operation of operating system, comprising:
a motherboard; and
a data storage device, comprising:
a controller comprising a firmware that defines an operating system recovery procedure;
a data transmission interface connected to the controller and the motherboard; and
a data storage unit, connected to the controller, and comprising:
a first system storage sector for storing an original operating system, wherein a monitoring program is installed in the original operating system, and used to periodically send an indication signal to the controller; and
a second system storage sector for storing a backup operating system;
wherein if the controller doesn't receive the indication signal sent from the monitoring program, the firmware will execute an operating system recovery procedure to recover the original operating system of the first system storage sector via the backup operating system of the second system storage sector.

2. The computer system according to claim 1, wherein the data storage device further comprises a timer that is configured in the data storage device in a form of circuit, or configured in the firmware of the controller in a form of software; the firmware will execute the operating system recovery procedure if the controller doesn't receive the indication signal sent from the monitoring program in a predetermined time counted by the timer.

3. The computer system according to claim 1, wherein the controller comprises an input and output pin, the motherboard comprises a reset pin, the input and output pin is connected to the reset pin; if the controller doesn't receive the indication signal sent from the monitoring program, the controller executes a resetting operation of the computer system by controlling the reset pin via the input and output pin; if the controller doesn't still receive the indication signal sent from the monitoring program after the resetting operation of the computer system has finished, the firmware will execute the operating system recovery procedure.

4. The computer system according to claim 1, wherein a state of the first system storage sector is preset as a display state by the firmware, and a state of the second system storage sector is preset as a hidden state by the firmware; the second system storage sector is an over provisioning sector of the data storage unit.

5. A computer system capable of self-monitoring and restoring an operation of operating system, comprising:
a motherboard; and
a data storage device, comprising:
a controller comprising a firmware, wherein the firmware defines a boot pointer offset procedure;
a data transmission interface connected to the controller and the motherboard; and
a data storage unit, connected to the controller, and comprising:
a first system storage sector, used for storing an original operating system, and comprising a first initial sector address; wherein a monitoring program is installed in the original operating system, and used to periodically send an indication signal to the controller; and
a second system storage sector, used for storing a first backup operating system, and comprising a second initial sector address:
wherein a boot pointer is preset by the firmware to point to the first initial sector address of the first system storage sector; if the controller doesn't receive the indication signal sent from the monitoring program, the firmware executes the boot pointer offset procedure to offset the boot pointer from pointing to the first initial sector address to pointing to the second initial sector address, and then executes a boot operation by the first backup operating system.

6. The computer system according to claim 5, wherein the data storage device further comprises a timer that is configured in the data storage device in a form of circuit, or configured in the firmware of the controller in a form of software; the firmware will execute the boot pointer offset procedure if the controller doesn't receive the indication signal sent from the monitoring program in a predetermined time counted by the timer.

7. The computer system according to claim 5, wherein the controller comprises an input and output pin, the motherboard comprises a reset pin, the input and output pin is connected to the reset pin; if the controller doesn't receive the indication signal sent from the monitoring program, the controller executes a resetting operation of the computer system by controlling the reset pin via the input and output pin; when the controller doesn't still receive the indication signal sent from the monitoring program after the resetting operation of the computer system has finished, the firmware will execute the boot pointer offset procedure.

8. The computer system according to claim 5, wherein the firmware defines an operating system recovery procedure, the data storage unit further comprises a third system storage sector used for storing a second backup operating system; when the first backup operating system finishes the boot operation and operates normally, the firmware executes the operating system recovery procedure to recover the original operating system of the first system storage sector by the second backup operating system of the third system storage sector.

9. The computer system according to claim 5, wherein a state of the first system storage sector is preset as a display state by the firmware, the second system storage sector is a first over provisioning sector of the data storage unit, the third system storage sector is a second over provisioning sector of the data storage unit, states of the second system storage sector and the third system storage sector are preset as hidden states by the firmware; when the boot pointer is offset from pointing to the first initial sector address to pointing to the second initial sector address, the firmware converts the state of the first system storage sector from the display state to the hidden state, and converts the state of the second system storage sector from the hidden state to the display state.

10. A method for capable of self-monitoring and restoring an operation of operating system, which is applied to a computer system, wherein the computer system comprises a motherboard and a data storage device; the data storage device comprises a controller, a data transmission interface, and a data storage unit; the controller comprises a firmware that defines an operating system recovery procedure; the data storage unit comprises a first system storage sector and a second system storage sector; the first system storage sector stores an original operating system installed with a monitoring program, and the second system storage sector stores a backup operating system, the method comprising:
sending an indication signal to the controller via the monitoring program periodically; and
executing the operating system recovery procedure by the firmware if the controller doesn't receive the indication signal sent by the monitoring program to recover the original operating system of the first system storage sector by the backup operating system of the second system storage sector.

11. The method according to claim 10, the method further comprising:
executing the operating system recovery procedure by the firmware if the controller doesn't receive the indication signal sent from the monitoring program in a predetermined time counted by a timer.

12. The method according to claim 10, the method further comprising:
executing a resetting operation of the computer system by the controller if the controller doesn't receive the indication signal sent from the monitoring program; and
executing the operating system recovery procedure by the firmware if the controller doesn't still receive the indication signal sent from the monitoring program after the resetting operation of the computer system has finished.

13. A method for capable of self-monitoring and restoring an operation of operating system, which is applied to a computer system, wherein the computer system comprises a motherboard and a data storage device; the data storage device comprises a controller, a data transmission interface, and a data storage unit; the controller comprises a firmware that defines a boot pointer offset procedure; the data storage unit comprises a first system storage sector and a second system storage sector; the first system storage sector stores an original operating system installed with a monitoring program, and comprises a first initial sector address; the second system storage sector stores a first backup operating system, and comprises a second initial sector address, the method comprising:
sending an indication signal to the controller via the monitoring program periodically; and
executing the boot pointer offset procedure by the firmware to offset the boot pointer from pointing to the first initial sector address to pointing to the second initial sector address such that a boot operation is executed by the first backup operating system.

14. The method according to claim 13, the method further comprising:
executing the boot pointer offset procedure by the firmware if the controller doesn't receive the indication signal sent from the monitoring program in a predetermined time counted by a timer.

15. The method according to claim 13, the method further comprising:
executing a resetting operation of the computer system by the controller if the controller doesn't receive the indication signal sent from the monitoring program; and
executing the boot pointer offset procedure by the firmware if the controller doesn't still receive the indication signal sent from the monitoring program after the resetting operation of the computer system has finished.

16. The method according to claim 13, wherein the firmware defines an operating system recovery procedure, the data storage unit further comprises a third system storage sector used for storing a second backup operating system; when the first backup operating system finishes the boot operation and operates normally, the method executed by the firmware of the controller further comprising:
executing the operating system recovery procedure to recover the original operating system of the first system storage sector by the second backup operating system of the third system storage sector.
